(19) United States
(12) Patent Application Publication
(10) Pub. No.: US 2010/0200309 A1
(43) Pub. Date: Aug. 12, 2010

(54) TWO-DIMENSIONAL POSITION SENSOR

(76) Inventors: Esat Yilmaz, Chandler's Ford (GB); Samuel Brunet, Cowes (GB); Nigel S.D. Hinson, Lymington (GB)

Correspondence Address: SCHWEGMAN, LUNDBERG & WOESSNER / ATMEL, P.O. BOX 2938, MINNEAPOLIS, MN, 55402, US

(21) Appl. No.: 12/670,632

(22) PCT Filed: Jul. 18, 2008
(86) PCT No.: PCT/GB2008/002470

§ 371 Date: Apr. 8, 2010

(30) Foreign Application Priority Data
Jul. 25, 2007 (GB) 0714518.8

(51) Int. Cl. G06F 3/041

(52) U.S. Cl. 178/18.03

(57) ABSTRACT

A sensor for determining a position of an object in two dimensions is provided. The sensor comprises a substrate with a sensitive area defined by a pattern of electrodes arranged thereon. The pattern of electrodes comprises four drive electrodes arranged in a two-by-two array and coupled to respective drive channels, and a sense electrode coupled to a sense channel. The sense electrode is arranged so as to extend around the four drive electrodes (i.e. to wholly or partially surround the drive electrodes, for example, so as to extend adjacent to at least three sides of the drive electrodes). The sensor may further comprise a drive unit for applying drive signals to the respective drive electrodes, and a sense unit for measuring sense signals representing a degree of coupling of the drive signals applied to the respective drive electrodes to the sense electrode. Furthermore the sensor may comprise a processing unit for processing the sense signals to determine a position of an object adjacent the sensor. The functionality of the drive channels, the sense channels, and the processing unit may be provided by a suitably programmed microcontroller.

### BACKGROUND OF THE INVENTION

The invention relates to sensors for determining the position of a pointing object, such as a user's finger, in two dimensions.

Capacitive position sensors have recently become increasingly common and accepted in human interfaces and for machine control. For example, in the fields of portable media players it is now quite common to find capacitive touch controls operable through glass or plastic panels. Some mobile (cellular) telephones are also starting to implement these kinds of interfaces.

More recently there has been the appearance of so-called ‘scroll wheels’ as input devices. These are rotary input devices such as those used in the Apple Inc. iPod™ MP3 player. An input device of this type is described in U.S. Pat. No. 7,046,230 [1]. The devices described in U.S. Pat. No. 7,046,230 are based on sensors arranged in zones within a sensing area. Activation of a given sensor indicates that the pointing object is adjacent the corresponding zone. In order to provide a reasonable degree of position sensing resolution, a relatively large number of zones, and corresponding large number of sensors, are required. For example, to achieve the 2 degree positional resolution around a full-circle which is suggested in one example in U.S. Pat. No. 7,046,230 a total of 180 sensors are required. To control this many sensors a significant amount of associated control circuitry is required. This increases cost, size and power consumption. The latter two of these are especially important in devices intended for user portability.

FIG. 1 schematically shows an angular position sensor 2 provided by Quantum Research Group under the brand name QWheel™. One such example product is Quantum Research Group's QT511. The sensor is operable to determine the position of a finger around a circular path. The sensor 2 comprises a sensor area defined by three sense electrodes 4A, 4B, 4C. Each sense electrode is connected to a capacitance measurement channel in a capacitance measurement circuit 6. The capacitance measurement circuit 6 is operable to measure the capacitance to a system reference potential (ground) of each of the respective sense electrodes 4A, 4B, 4C, and to output corresponding measurement signals to a controller 8. The controller is operable to determine an angular position estimate θ for a pointing object relative to an arbitrarily selected zero direction (marked 0° in FIG. 1) from the supplied measurement signals. The controller 8 may then provide an output signal indicative of the determined angular position θ for use by a device controller of the device in which the sensor 2 is incorporated.

The principle of operation is as follows. When there is no pointing object near to the sense electrodes 4A, 4B, 4C, the measured capacitances have background/quiescent values. These values depend on the geometry and layout of the sense electrodes and the connections to them, and so on, as well as the nature and location of neighbouring objects, e.g. the sense electrodes' proximity to nearby ground planes. When a user's finger approaches a sense electrode, the finger appears as a virtual ground. This serves to increase the measured capacitance of the sense electrode to ground. Thus an increase in measured capacitance is taken to indicate the presence of a finger. The extent to which the capacitance of a given one of the sense electrodes changes will depend on the extent to which the user's finger overlaps with that particular sensing electrode (since this primarily determines the degree of capacitive coupling). This in turn will depend on the angular position of the user's finger around the sensor because of the varying shapes of the electrodes around the sensor.

For example, in FIG. 1, the outline of a user's finger over the sensing area of the sensor 2 is schematically shown by a hatched area 10. The finger does not directly overlap with sense electrode 4C and so there will be no significant change in measured capacitance for that electrode. However, the finger does directly overlap with sense electrode 4A and 4B, furthermore the areal extent of the overlap is about the same for both electrodes. This means the controller 8 will be provided with measurement signals indicating no significant change in measured capacitance for sense electrode 4C, and broadly equal changes in measured capacitances for sense electrodes 4A and 4B. The controller can determine from these relative changes that the centroid of the touch must be at an angular position of around 60 degrees. This is because this is the location at which a pointing finger would have no overlap with sense electrode 4C, and similar overlaps with sense electrodes 4A and 4B.

The capacitance measurement channels used in the sensor 2 shown in FIG. 1 are based on what might be termed “passive” capacitive sensing techniques. Passive capacitive sensing devices such as this (passive sensors) rely on measuring the capacitance of an electrode (e.g. the sense electrodes 4A, 4B, 4C) to a system reference potential (earth). The fundamental principles underlying this type of sensor are as described in U.S. Pat. No. 5,730,165 [2] and U.S. Pat. No. 6,466,036 [3], for example.

The functionality of the capacitance measurement circuit 6 and the controller 8 in the sensor 2 shown in FIG. 1 can be provided by a relatively modest microcontroller, such as the Tiny44 microcontroller provided by Atmel™. This is possible because the sensor 2 shown in FIG. 1 relies on only three sense electrodes. It thus requires much less associated circuitry than sensors of the kind described in U.S. Pat. No. 7,046,230. This means it can be made more cheaply and more space efficient than sensors of the kind described in U.S. Pat. No. 7,046,230.

The sensor 2 shown in FIG. 1 has been found to be useful and reliable in a number of applications. However, there are some drawbacks associated with its reliance on passive capacitance measurement techniques. For example, passive sensors are strongly sensitive to external ground loading. That is to say, the sensitivity of such sensors can be significantly reduced by the presence of nearby low impedance connections to ground. This places some constraints on how the sensors can be integrated into a device. For example, some types of display screen technology provide for a low-impedance coupling to ground across the visible screen. This means sensors based on passive capacitance measurement techniques will often under-perform if they are located in a device over, or near to, a display screen. This is because the strong coupling to ground through the screen itself reduces the sensitivity to additional coupling to ground caused by an approaching finger. A similar effect means passive sensors such as shown in FIG. 1 can be relatively sensitive to changes in their environment. For example, the sensor 2 in FIG. 1 may behave differently according to its location because of differences in capacitive coupling (ground loading) to external objects. Passive sensors are also relatively sensitive to environmental conditions, such as temperature, humidity, accumulated dirt and spilt fluids, etc. All of these effect the sensor's reliability and sensitivity. Furthermore, the capacitance measurement circuitry associated with passive sensors is generally of high input impedance. This makes passive sensors prone to electrical noise pick up, e.g. radio frequency (RF) noise. This can reduce reliability/sensitivity of the sensor and also places further constraints on sensor design (e.g. there is limited freedom to use relatively long connection leads/traces between the sensing electrodes and associated circuitry.

Accordingly, there is a need for a two dimensional capacitive position sensor that is simpler to implement and requires less complex circuitry than sensors of the kind described in U.S. Pat. No. 7,046,230, but which does not suffer so extensively from the above-mentioned drawbacks of the sensor shown in FIG. 1.

### SUMMARY OF THE INVENTION

According to one aspect of the invention there is provided a sensor for determining a position of an object in two dimensions, the sensor comprising a substrate with a sensitive area defined by a pattern of electrodes arranged thereon, wherein the pattern of electrodes comprises four drive electrodes arranged in a two-by-two array and coupled to respective drive channels, and a sense electrode coupled to a sense channel, wherein the sense electrode is arranged so as to extend around the four drive electrodes.

The sensor may further comprise a drive unit for applying drive signals to the respective drive electrodes, and a sense unit for measuring sense signals representing a degree of coupling of the drive signals applied to the respective drive electrodes to the sense electrode. Furthermore the sensor may comprise a processing unit for processing the sense signals to determine a position of an object adjacent the sensor. (The functionality of the drive channels, the sense channels, and the processing unit may be provided by a suitably programmed microcontroller.)

Thus a simple two-dimensional sensor is provided that relies on only five discrete electrodes (four drive electrodes and one sense electrode). This means a simple controller chip having a relatively low number of input/output pins may be employed. Furthermore, this may be achieved in a way that does not rely on passive capacitive sensing techniques. This means the sensor is more stable (e.g. less prone to variations in temperature, supply voltage etc.), more tolerant of nearby ground loading and moisture effects, and may also acquire position estimates faster (with correspondingly smaller power requirement) than a sensor such as that shown in FIG. 1. Furthermore still, the sensor can employ similar circuitry components to those employed in existing passive capacitive sensors of the kind shown in FIG. 1, for example similar microcontrollers could be used with appropriate changes made to their programmed mode of operation. This makes sensors according to embodiments of the invention relatively easy to implement as replacements for sensors of the kind shown in FIG. 1.

The processing unit may be operable to determine a position of an object adjacent the sensor based on a ratiometric analysis of the sense signals associated with different drive electrodes. For example, the processing unit may be operable to determine the position of an object adjacent the sensor in one direction based on a ratio of a sum of the sense signals associated with an adjacent pair of drive electrodes to a sum of the sense signals associated with all of the drive electrodes. In this case the adjacent pair of drive electrodes may comprise two drive electrodes separated along a direction normal to the direction along which the position is determined. This kind of ratiometric analysis can assist in automatic normalization to different magnitudes of overall capacitive coupling (e.g. to reduce dependence on pointing object size).

The two-by-two array of drive electrodes may be a square array and may be wholly surrounded by the sense electrode. Furthermore, individual ones of the drive electrodes may be wholly surrounded by the sense electrode. Alternatively, the drive electrodes may only be partially surrounded by the sense electrode, e.g. to accommodate openings in the electrode pattern. For example, the drive electrodes may individually be surrounded by around at least 270 degrees of azimuth about their respective peripheries by the sense electrode. Similarly, the two-by-two array of drive electrodes as a whole may be surrounded by around at least 270 degrees of azimuth by the sense electrode.

The sensor may further comprise a ring electrode arranged around the periphery of the sensitive area and coupled to a system ground. This can help in defining an edge to the sensitive area.

The drive electrodes and the sense electrode may be arranged on a first side of the substrate and the sensor may further comprise an extended ground-plane electrode arranged on a second opposing side of the substrate and coupled to a system ground. This provides a uniform fixed ground loading across the sensitive area of the sensor and so can help reduce the effects of nearby ground loading. The extended ground-plane electrode may comprises an open mesh pattern to reduce its impact on sensor sensitivity. E.g. the open mesh pattern may have a fill factor in a range selected from the group comprising 20% to 80%, 30% to 70%, 40% to 60% and 45% to 55%.

The sensor may be mounted beneath a cover panel having a thickness T. A gap between the drive electrodes and the sense electrode may have a width of between one-third and two-thirds the thickness T of the cover panel. This arrangement can help provide a good coupling between the drive and sense electrodes and sensitivity to nearby pointing objects, e.g. a user's finger.

The sensor may have a characteristic extent W (i.e. the extent of its sensitive area may be on this order) along a first direction, and the drive electrodes may have widths of between W/10 and W/3 along the first direction. Furthermore, the sensitive area may also have a characteristic extent W along a second direction, and the drive electrodes may also have widths of between W/10 and W/3 along this direction. Portions of the sense electrode between adjacent drive electrodes may have widths of between W/20 and W/5 along the first and/or second directions.

These characteristic sizes for the various elements of the sensor have been found to provide good response characteristics, e.g. in terms of linearity of response.

The sensitive area as a whole may have a characteristic extent on the order of, or less than a dimension selected from the group comprising 30 mm, 25 mm, 20 mm, 15 mm, 10 mm and 5 mm. These are suitable sizes for detecting the position of an object having a characteristic size on the order of the size of a typical user's finger tip. If the sensor is made much greater that 30 mm in size, it can have response flat spots (since it is primarily sensitive to pointing objects adjacent the gaps between the drive and sense electrodes). If the sensor is made too small in size, it can become too insensitive. For example, the sensor may have a characteristic size selected from the group comprising 0.5, 1, 1.5, 2 and 2.5 times the size of a pointing object to be sensed. This helps in allowing a pointing object to modify the capacitive coupling associated with each drive electrode regardless of its position over the sensitive area.

The sensor may further comprise a mechanical switch and the substrate may be moveably mounted with respect to the mechanical switch so that a movement of the substrate is operable to activate the mechanical switch. This allows a user to control a selection cursor on a display of a device being controlled using the position sensitive aspects of the sensor, and then to make a selection by pressing down on the sensor to activate the mechanical switch, for example. A microcontroller for operating the sensor may be operable to supply a drive signal to a drive electrode through an input/output (I/O) connection at one time, and to sample the status of the mechanical switch through the same input/output (I/O) connection at a another different time. This allows one, or more, mechanical switches to be employed without requiring extra input/output lines for the sensor controller.

According to a second aspect of the invention there is provided a device comprising a sensor according to the first aspect of the invention. For example, sensors according to the first aspect of the invention may be used in cellular telephones, ovens, grills, washing machines, tumble-dryers, dish-washers, microwave ovens, food blenders, bread makers, drinks machines, computers, home audiovisual equipment, portable media players, PDAs, cell phones, computers, and so forth.

### BRIEF DESCRIPTION OF THE DRAWINGS

For a better understanding of the invention and to show how the same may be carried into effect reference is now made, by way of example to the accompanying drawings in which:

FIG. 1 schematically shows a known sensor for determining the position of an object around a circular path;

FIG. 2 schematically shows a sensor for determining the position of an object in two dimensions according to an embodiment of the invention;

FIGS. 3 to 5 schematically show section views of the sensor of FIG. 2 during use;

FIG. 6A schematically shows an electrical circuit for use with sensors according to embodiments of the invention;

FIG. 6B schematically shows the timing relationship between some elements of the circuit shown in FIG. 6A;

FIGS. 7A and 7B schematically show section views of a portion of the sensor shown in FIG. 2 with overlaying characteristic electric field lines;

FIG. 8A schematically shows a sequence of drive signals supplies by drive channels to drive electrodes of the sensor shown in FIG. 2;

FIG. 8B schematically shows the magnitude of a component of the respective drive signals shown in FIG. 8A coupled to a sense electrode of the sensor shown in FIG. 2 during a measurement acquisition cycle;

FIG. 8C schematically shows the magnitude of an input voltage to a mechanical switch sense channel of the sensor shown in FIG. 2 during a measurement acquisition cycle;

FIG. 9 schematically shows notional sensor zones for the sensor of FIG. 2;

FIGS. 10 to 14 schematically show portions of sensors for determining the position of an object in two dimensions according to other embodiments of the invention; and

FIG. 15 schematically shows a mobile telephone incorporating a sensor according to an embodiment of the invention.

### DETAILED DESCRIPTION

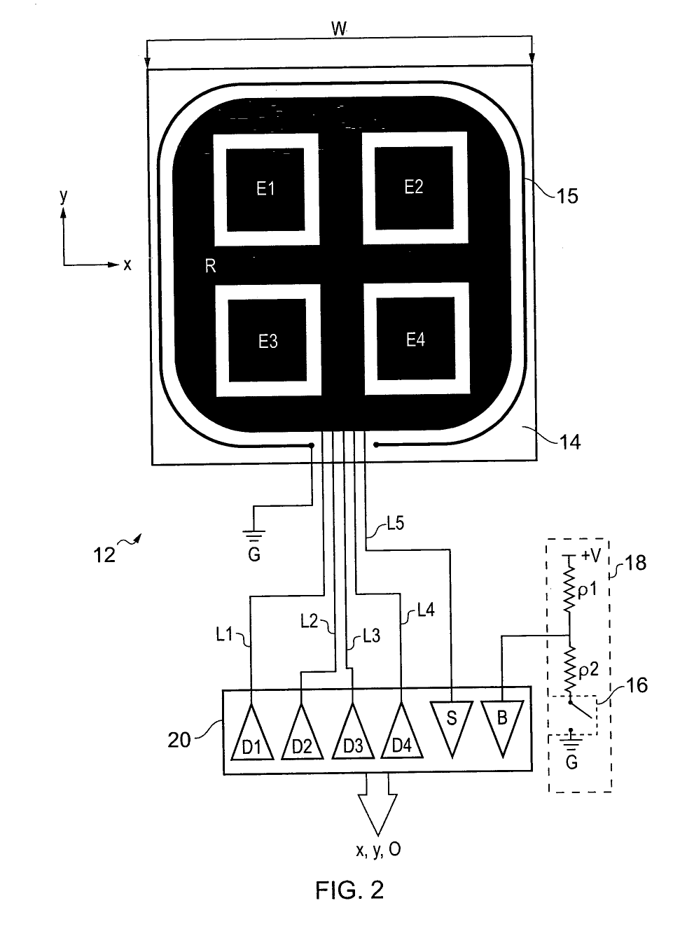

FIG. 2 schematically shows a sensor 12 for determining a position of an object in two dimensions according to an embodiment of the invention. In this example the two directions are a horizontal direction X and a vertical direction Y for the orientation of the sensor shown in FIG. 2.

The sensor 12 comprises a substrate 14 bearing an electrode pattern defining a sensitive area of the sensor and a controller 20. The sensor also comprises a mechanical switch 16 (shown highly schematically in FIG. 2) and associated switch circuitry 18 (comprising voltage supply +V; first and second resistors ρ1 and ρ2; connection to a system reference potential (ground) and associated wiring).

The electrode pattern consists of four drive electrodes E1, E2, E3, E4 arranged in a two-by-two array and a single electrically continuous sense electrode R arranged to extend around the four drive electrodes. The controller 20 provides the functionality of four drive channels D1, D2, D3, D4 for supplying drive signals to respective ones of the four drive electrodes E1, E2, E3, E4 and a sense channel S for sensing signals from the sense electrode R. In this example a separate drive channel is provided for each drive electrode. However, a single drive channel with appropriate multiplexing may also be used. The controller also contains a mechanical switch sense channel B coupled to the circuitry associated with the mechanical switch 16. The drive and sense channels in the controller are coupled to their respective drive and sense electrodes by routing connections L1, L2, L3, L4 and L5 (the specific routing of these wires within the sensitive area of the sensor 12 is not shown in FIG. 2).

The controller 20 further contains a processing unit (not shown) for calculating a position of an object (e.g. a user's finger) adjacent the sensitive area of the sensor. This calculation is based on a comparison of the different sense signals observed as drive signals are applied to different ones of the drive electrodes while a pointing object is adjacent the sensitive area. The processing unit is further operable to determine the status of the mechanical switch (i.e. open or closed) based on the output of the mechanical switch sense channel B. The controller 20 is configured to output a position signal indicating X and Y coordinates for the calculated position of a pointing object and a mechanical switch signal O indicating whether the mechanical switch 16 is open or closed. This output information may then be used by a main controller of a device/apparatus in which the sensor is incorporated and the appropriate action taken in correspondence with the determined user input.

The drive channels D1, D2, D3, D4, sense channel S, and mechanical switch sense channel B are shown schematically in FIG. 2 as separate elements within the controller 20, and also as elements separate from the processing unit element. However, in general the functionality of all these elements will be provided by a suitable programmed single integrated circuit chip, for example a suitably programmed general purpose microprocessor, or field programmable gate array, or an application specific integrated circuit. In this example the controller 20 functionality is provided by a suitably programmed Atmel Tiny44 microcontroller.

The electrode pattern on the substrate 14 can be provided using conventional techniques (e.g. lithography, deposition, or etch techniques). The substrate 14 in this example is of a conventional rigid printed circuit board (PCB) material and the electrodes formed from a layer of copper deposited thereon in conventional manner. In other examples the substrate may be flexible. The substrate may also be of a transparent plastics material, e.g. Polyethylene Terephthalate (PET) and the electrodes comprising the electrode pattern may be formed of a transparent conductive material, e.g. Indium Tin Oxide (ITO). Thus in these cases the sensitive area of the sensor as a whole would be transparent. This means the sensor may be fully rear-illuminated or used over an underlying display without obscuration, for example.

The sensor 12 additionally includes a guard ring electrode 15. This is arranged on the substrate 14 and runs around the majority of the periphery of the sensitive area provided by the disposition of the drive and sense electrodes. The guard ring electrode 15 is connected to a system reference potential G (i.e. ground/earth). The guard ring helps in defining a clean “edge” to the sensitive area by sinking stray electric fields and also provides some protection against electrostatic charge build-up and discharge since it provides a direct connection to ground which bypasses the sense and drive channels.

The dimensions of features of the sensor 12 shown in FIG. 2 may be defined in terms of fractions of the sensor's overall characteristic extent W. Furthermore, some dimensions may advantageously be determined in dependence on the thickness T of a cover panel overlaying the sensor.

For example, the sensitive area of the sensor 12 shown in FIG. 2 in effect is in the shape of a square with rounded corners. Thus the characteristic linear extent of the sensor is the same in both directions X and Y. In this example it is assumed that the sensitive area extends over most of the area of the substrate 14 and so the characteristic extent of the sensitive area broadly corresponds with the size of the substrate. In this example the substrate is square with an overall width W of 16 mm. In other cases the substrate may be significantly larger than the extent of the sensitive area of the sensor (e.g. because it carries other sensors or electronics). In these cases the characteristic extent W of the sensor may be taken to be the extent of the sense electrode itself, or the separation between the guard ring electrode 15 on opposing sides of the sensitive area, for example. Furthermore, it is assumed in this example that the sensor is positioned behind a cover panel having a thickness of 1.5 mm.

The example sensor shown in FIG. 2 has dimensions for the various elements as follows. (These are dimensions along lines parallel to the X/Y directions.) The distance between the edge of the substrate 14 and the guard ring electrode 15 is 0.25 mm. As noted above, this distance is not of any real significance to the operation of the sensor. The thickness of the guard ring electrode 15 is 0.2 mm. This too is not significant to the operation of the sensor. For example, the guard ring electrode could be much wider to the extent it becomes in effect a ground plane with the sensitive area of the sensor being located in an opening within this ground plane. The guard ring electrode 15 is separated from the sense electrode by 0.38 mm. This distance is selected as being approximately equal to T/4 (T being the 1.5 mm thickness of the overlaying cover panel), and in this example is thus around W/40 (W being the characteristic overall width of the sensitive area). In other examples, the separation between the guard ring electrode 15 and the sense electrode R may be relatively wider or narrower, e.g. having a size of between T/8 and T/2.

Consider now an imaginary line running parallel to the X-direction and passing through the upper two drive electrodes E1, E7 of the sensor 12 in FIG. 2. Moving along the line from left to right (for the orientation shown in FIG. 2) the line intersects the sense electrode R in three places (i.e. to the left of drive electrode E1, between drive electrodes E1 and E2, and to the right of drive electrode E2). The width of these three segments of the sense electrode R along the imaginary line are in this example the same and are 1.62 mm each. This is approximately W/10. In other examples the sensor may be arranged so that these segments of the sense electrode are relatively wider or narrower, e.g. having widths between W/5 and W/20. Furthermore, they do not need to all be the same width. The drive electrodes in this example also have the same widths along the imaginary line, and these width are around 3.24 mm. This is approximately W/5. Again, in other examples these dimensions may be relatively larger or smaller, e.g. between W/3 and W/10.

The gaps in the electrode patterning between the drive electrodes and the sense electrodes along the imaginary line are in this example all 0.75 mm. This distance is selected as being approximately equal to T/2, which here corresponds to around W/20. In other examples, these gaps may be relatively wider or narrower, e.g. having size of between T/4 and T. For example, smaller gaps may be appropriate where there is a relatively high degree of ground loading in the vicinity of the electrodes.

In this example the sensor has a high degree of symmetry and so characteristic dimensions are the same in X and Y. However, this need not be the case in other examples.

It will be appreciated that the above dimensions are provided merely to give an indication of the typical sizes that may be used and which have been found in practice to give good sensitivity and linearity in a relatively small/compact sensor. The various elements of other sensors according to embodiments of the invention may have different sizes, both absolutely and also relative to one another. For example, in a sensor that is twice the size of the sensor shown in FIG. 2, (e.g. having a characteristic width of around 30 mm) the dimensions of the various elements may be on the whole around twice as large. However, there may be some differences. For example, if a sensor that is twice as large is nonetheless still positioned beneath a cover panel having a thickness of 1.5 mm, it may be preferable to maintain the gaps between the drive and sense electrodes and between the sense electrode and the guard ring electrode at around 0.75 mm (T/2) and 0.38 mm (T/4) respectively. The other elements (e.g. drive electrodes and the various segments of the sense electrode) may thus be relatively larger. In general an empirical analysis or modelling may be performed to ascertain the most appropriate dimensions for a given sensor configuration (e.g. for a given characteristic size, materials used (e.g. dielectric constant of cover panel) etc.).

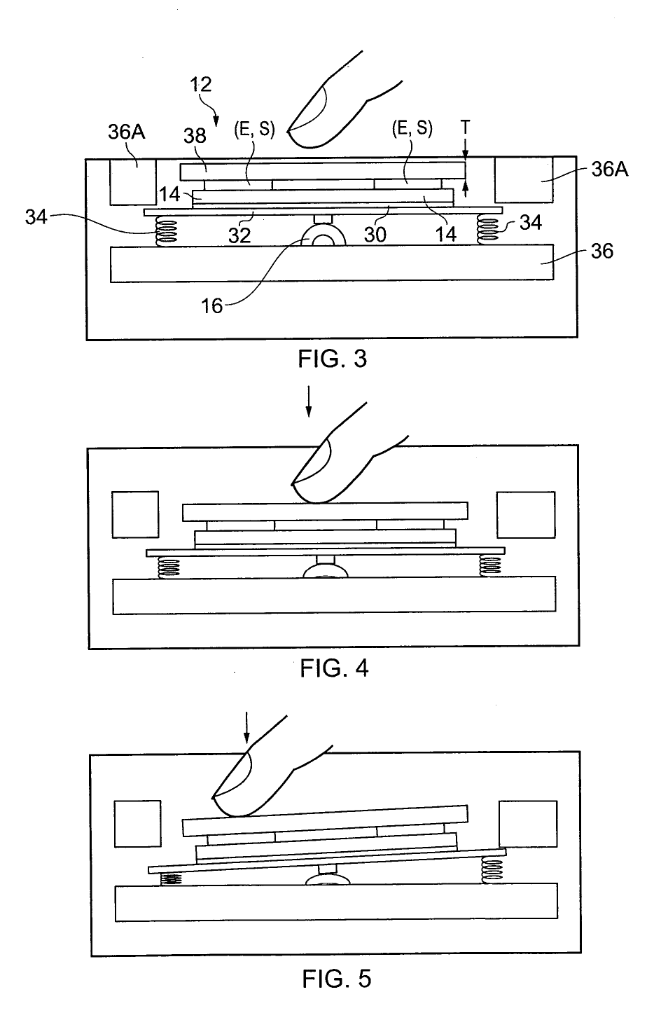

FIG. 3 schematically shows the sensor 12 of FIG. 2 in vertical section view. The sensor is shown mounted within a mounting structure provided by a device being controlled (e.g. a mobile telephone or media player). The mounting structure comprises a base part 36 and surrounding wall parts 36A. The base part 36 may, for example, be a printed circuit board of the device being controlled. The wall parts 36A may be parts of an outer housing of the device being controlled The parts of the sensor described above in relation to FIG. 2 which are shown in FIG. 3 include the sensor substrate 14, the electrode patterning comprising the drive and sense electrodes, and the mechanical switch 16.

The electrode patterning comprising the drive and sense electrodes is collectively indicated in FIG. 3 by reference symbol (E, R). It will be appreciated that this patterning is shown highly schematically in FIG. 3 in that it does not correspond in layout to any particular part of the pattern shown in FIG. 2, and furthermore is shown as being much thicker than it would typically be relative to the other elements of the sensor.

Also shown in FIG. 3 is a protective cover panel 38 having a thickness T (here around 1.5 mm). This is adhered over the drive and sense electrodes (E, R) in conventional manner. The cover panel here is glass. In other examples, the cover panel may be another material, e.g. PMMA, PVC, polycarbonate, ABS etc. A dielectric constant greater than 2.5 may be preferred for the cover panel.

Further elements of the sensor 12 shown in FIG. 3 are a ground plane 30, a floating platform 32, and biasing elements, here springs 34.

The ground plane 30 is an area of conductive material mounted to the underside side of the substrate 14 (i.e. the side opposite the side on which the drive and sense electrodes are mounted) and extending over an area broadly corresponding to the sensitive area of the sensor (i.e. over the majority of the substrate in this example). The ground plane 30 has the advantage of screening the drive and sense electrodes from any underlying circuitry. The sensor is relatively robust to the presence of nearby circuitry, but the sensor operation can nonetheless be affected to some extent by changes in nearby circuitry. This happens if the sensor is moved within the mounting structure as discussed further below because its separation from nearby circuitry changes in places. This change in surroundings can affect the sensor operation by modifying its response characteristics. The presence of the ground plane 30 connected to a system ground G helps to reduce these effects. The ground plane may be a uniformly filled area, but in this case comprises a mesh pattern. The ground plane 30 further includes open channels (not apparent in FIG. 3) along which connections between the controller 20 and the respective electrodes may be routed before connecting to their respective electrodes through pass-throughs in the substrate.

To a large extent the routing connections L1, L2, L3, L4, L5 may follow any appropriate path. However, the effect of the routing connections L1, L2, L3, L4, L5 on the operation of the sensor can be minimised if some routing considerations are taken into account. For example, the routing connections to the respective drive electrodes E1, E2, E3, E4 may preferentially be routed so that they do not pass underneath any of the other drive electrodes. For example, referring to FIG. 2, the routing connection L1 to the drive electrode E1 should not pass in a straight line directly underneath drive electrode E3, but should “skirt” around it. The routing connection L5 to the sense electrode R is more prone to disturbance. Where possible, the routing connection L5 should preferentially not run in close proximity to ground planes, should be separated so far as possible from the other routing connections, e.g. it may be advantageous to separate the routing connection to the sense electrode from routing connections to the drive electrodes by at least twice the width of the routing connection to the sense electrode. It may also be advantageous if the routing connection to the sense electrode R is formed on a layer that is not in-front of the sense electrode as viewed by an approaching pointing object (to the extent it runs over the sense electrode itself). Connections between moveable parts of the senor 12 (such as the substrate, drive and sense electrodes, etc) and the fixed non-moveable parts of the sensor (such as the controller 20) may be made via a conventional flexible connector, e.g. a ribbon connector (to the extent the controller is not also mounted on the moveable substrate).

The floating platform 32 supports the above-mentioned elements of the sensor 12. The floating platform is resiliently mounted to the mounting structure 36, 36A so that it is free to move to some extent within the mounting structure. In FIG. 3 the resilient mounting is schematically shown as a pair of helical springs 34 connecting the floating platform to the mounting structure base part 36. In other examples, other resilient elements may be used, or alternative means for mounting the sensor may be employed. E.g. a flexible cover panel (membrane) may extend over the sensor between mounting structure wall parts 36A. This has the advantage of providing a simple sealed outer surface. Such a flexible cover panel (membrane) may also replace the cover panel 38 of the sensor shown in FIG. 3 and render the floating platform 32 (and associated springs 34) redundant.

The mechanical switch 16 is mounted to the mounting structure base part 36 and underlies the floating platform 32. The mechanical switch 16 is arranged so that it is activated when the platform is moved from its normal resiliently biased position within the mounting structure 36, 36B by a pointing object exerting pressure on the cover panel. The mechanical switch 16 is a conventional deformable dome-type switch. This provides a galvanic contact upon closure by being compressed. Conveniently this type of mechanical switch provides a user with a mechanical “click-like” feedback upon being pressed. Other types of mechanical switch (i.e. switches based on mechanical pressure) could be used in other examples, for example a force sensing resister switch, an optical interrupter switch, a piezoelectric crystal switch, or capacitive switch operable by sensing two conductive plates moving relative to each other as a result of pressing. Such non-galvanic types of switch can have high longevity, since they can be relatively insensitive to corrosion, oxidation, or moisture effects and work cycling.

In this example the mechanical switch 16 is a conventional conductive rubber dome switch. However, other types of dome switch could also be used, for example metal dome switches, conductive plastic domes, tact buttons, membrane buttons, or other electromechanical switching devices, with or without tactile feedback. Such mechanical switches are generally configured to spring back into shape when no force is exerted upon them. This means the switch itself could provide the resilient mounting element for the floating platform and there may be no need for additional means such as the springs 34 shown in FIG. 3.

Thus the sensor 12 is free to move within the mounting structure 36, 38 if pressed upon by a user. A user's finger (not to scale) is shown in FIG. 3 adjacent the sensor 12, but not exerting any mechanical force on the sensor. Thus the sensor remains in its normal resiliently biased position with the mechanical switch in an open state. The sensor may be retained in this position against the biasing force provided by the springs 34 by mechanical stops not shown in FIG. 3. For example a resilient sealing gasket may be positioned between the floating platform and the mounting structure wall parts 36A. This gasket may be extendible so that a seal is retained when the floating platform 32 moves within the mounting structure 36, 36A.

FIGS. 4 and 5 are similar to and will be understood from FIG. 3. However, the sensor in FIGS. 4 and 5 is shown in a state in which the user's finger exerts pressure to overcome the biasing of the springs 34 (and any resilience in the mechanical switch) so that the sensor moves within the mounting structure. In FIG. 4 the user is shown pressing near to the middle of the sensor. The sensor thus moves as a whole within the mounting structure along the press direction. In FIG. 5 the user is shown pressing near to an edge of the sensor. The sensor thus pivots about its centre. In both cases the sensor moves by enough (typically only a few mm or less) that the mechanical switch is pressed down and activated. Although not shown in FIGS. 3 to 5, mechanical stops (e.g. rigid or resilient spacers) may be provided to prevent the user from forcing the sensor to move too far in the mounting structure, e.g. to prevent the mechanical switch being damaged.

Referring to the circuitry 18 associated with the mechanical switch 16 shown in FIG. 2, when the mechanical switch is in an open state (as in FIG. 3) the voltage seen at the mechanical switch sense channel B is the supply voltage +V. This is because the input to the mechanical switch sense channel B is pulled up by the connection to voltage supply +V through resistor ρ1. However, when the mechanical switch is in a closed state (as in FIGS. 4 and 5), the voltage seen at the mechanical switch sense channel B is only a fraction of the supply voltage +V. This is because the input to the mechanical switch sense channel B is in effect connected to a pick-off point in a voltage divider provided by resistors ρ1 and ρ2 connecting in series from the voltage supply +V to ground G through the now-closed mechanical switch 16. In this example the resistors ρ1 and ρ2 have values of around 1 MΩ and 100 kΩ respectively. Thus when the mechanical switch 16 is closed, the voltage at the input to the mechanical switch sense channel B is around +V/10 or so. Thus the mechanical switch sense channel B may comprise a simple voltmeter or a comparator to determine whether or not the mechanical switch is open or closed based on the voltage presented to it. Thus the processing unit in the controller is able to receive a signal from the mechanical switch sense channel B indicating whether or not the mechanical is activated and appropriately set output signal O accordingly.

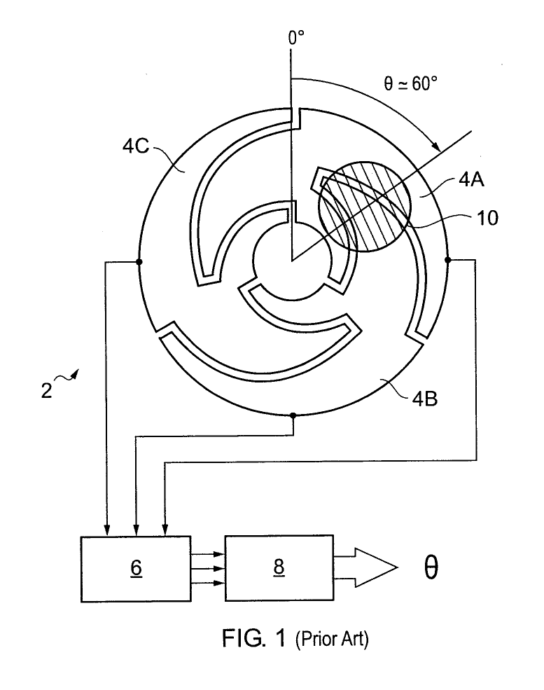

The operation of the sensor 12 shown in FIG. 2 in terms of determining a position for an adjacent object is now described.

Whereas the sensor 2 shown in FIG. 1 is based on passive capacitive sensing techniques, the sensor 12 is based on what might be termed active capacitive sensing techniques. In particular, the sensor 12 is based on measuring the degree of capacitive coupling between two electrodes (in this case between respective ones of the drive electrodes E1, E2, E3, E4 and the sense electrode S) instead of between a single floating electrode and a system ground. The principles underlying active capacitive sensing techniques are described in U.S. Pat. No. 6,452,514 [4]. The contents of U.S. Pat. No. 6,452,514 are incorporated herein by reference in their entirety as describing background material to the invention. In an active-type sensor, one electrode, the so called drive electrode, is supplied with an oscillating drive signal. The degree of capacitive coupling of the drive signal to the sense electrodes is determined by measuring the amount of charge transferred to the sense electrode by the oscillating drive signal. The amount of charge transferred, i.e. the strength of the signal seen at the sense electrode, is a measure of the capacitive coupling between the electrodes. When there is no pointing object near to the electrodes, the measured signal on the sense electrode has a background/quiescent value. However, when a pointing object, e.g. a user's finger, approaches the electrodes (or more particularly approaches near to the region separating the electrodes), the pointing object acts as a virtual ground and sinks some of the drive signal (charge) from the drive electrode. This acts to reduce the strength of the component of the drive signal coupled to the sense electrode. Thus a decrease in measured signal on the sense electrode is taken to indicate the presence of a pointing object.

A manner of operating the sensor 12 shown in FIG. 2 will now be described.

In use, the position of an object is determined in a measurement acquisition cycle in which the drive electrodes E1, E2, E3, E4 are sequentially driven by their respective drive channels D1, D2, D3, D4, and the amount of charge transferred to the sense electrode R from each of the drive electrodes is determined by the sense channel.

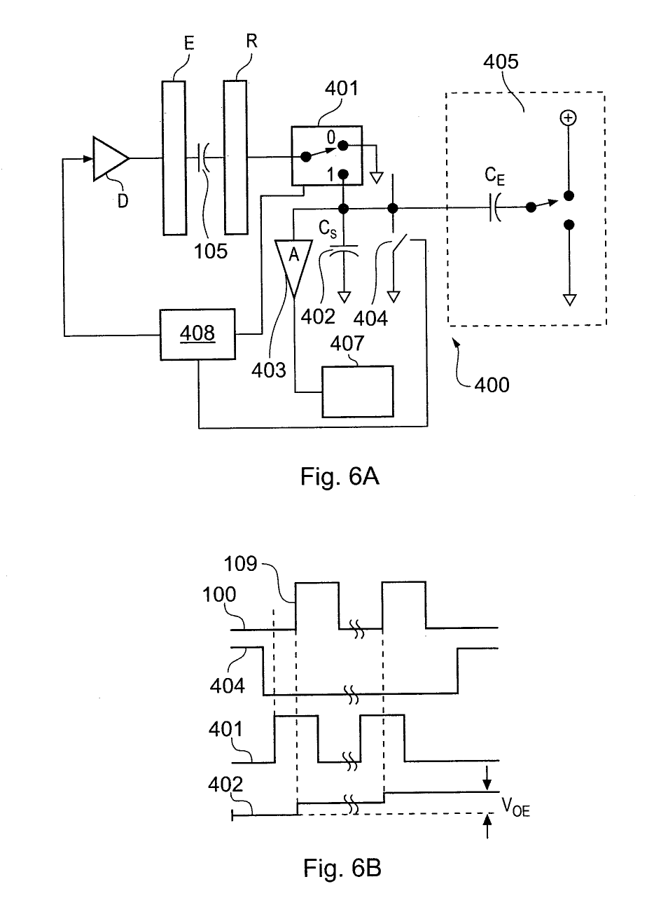

FIG. 6A schematically shows a circuit which may be used to measure the charge transferred from a driven one of the drive electrodes E1, E2, E3, E4 to the sense electrode S. While this is described below, at least in some respects, in the context of discrete circuit elements, as noted above the overall circuit functionality in the sensor 12 shown in FIG. 2 is primarily provided by a suitably programmed microcontroller.

The drive electrode which is being driven at a given time (hereafter referred to generically as drive electrode E) and the sense electrode R have a self (mutual) capacitance. This is determined primarily by their geometries, particularly in the regions where they are at their closest. Thus the driven drive electrode E is schematically shown as a first plate of a capacitor 105 and the sense electrode R is schematically shown as a second plate R of the capacitor 105. Circuitry of the type shown in FIG. 6A is more fully described in U.S. Pat. No. 6,452,514 [4]. The circuit is based in part on the charge-transfer (“QT”) apparatus and methods disclosed in U.S. Pat. No. 5,730,165 [1], the contents of which are herein incorporated by reference.

The drive channel associated with the presently driven electrode E (hereafter referred to generically as drive channel D), the sense channel S associated with sense electrode R and other elements of the -sensor controller 20 are schematically shown as combined processing circuitry 400 in FIG. 6A. The processing circuitry 400 comprises a sampling switch 401, a charge integrator 402 (shown here as a simple capacitor), an amplifier 403 and a reset switch 404, and may also comprise optional charge cancellation means 405. The timing relationships between the drive signal applied to the driven electrode E from the drive channel D and the sample timing of switch 401 is schematically shown in FIG. 6B. The drive channel D and the sampling switch 401 are provided with a suitable synchronizing means (e.g. common clock pulses) to maintain this relationship. In the implementation shown, the reset switch 404 is initially closed in order to reset the charge integrator 402 to a known initial state (e.g., zero volts). The reset switch 404 is then opened, and at some time thereafter the sampling switch 401 is connected to charge integrator 402 via terminal 1 of the switch for an interval during which the drive channel D emits a positive transition, and thereafter reconnects to terminal 0, which is an electrical ground or other suitable reference potential. The drive signal from the drive channel D then returns to ground, and the process repeats again for a total of ‘n’ cycles, (where n may be 1 (i.e. 0 repeats), 2 (1 repeat), 3 (2 repeats) and so on). It can be helpful if the drive signal does not return to ground before the charge integrator is disconnected from the sense electrode since otherwise an equal and opposite charge would flow into/out of the sense channel during positive and negative going edges, thus leading to no net transfer or charge into the charge detector. Following the desired number of cycles, the sampling switch 401 is held at position 0 while the voltage on the charge integrator 402 is measured by a measurement means 407, which may comprise an amplifier, ADC or other circuitry as may be appropriate to the application at hand. After the measurement is taken, the reset switch 404 is closed again, and the cycle is restarted, though with the next drive channel (e.g. D1, D2, D3 or D4) and drive electrode (e.g. E1, E2, E3 or E4) in the acquisition cycle sequence replacing the drive channel D and driven electrode E schematically shown in FIG. 6A. The process of making a measurement for a given driven electrode is referred to here as being a measurement ‘burst’ of length ‘n’. where ‘n’ can range from 1 to any finite number. The circuit's sensitivity is directly related to and inversely to the value of the charge integrator 402.

It will be understood that the circuit element designated as 402 (sampling capacitor Cₛ) provides a charge integration function that may also be accomplished by other means, and that this type of circuit is not limited to the use of a ground-referenced capacitor as shown by 402. It will also be appreciated that the charge integrator 402 can be an operational amplifier based integrator to integrate the charge flowing through in the sense circuitry. Such integrators also use capacitors to store the charge. It may be noted that although integrators add circuit complexity they provide a more ideal summing junction load for the sense currents and more dynamic range. If a slow speed integrator is employed, it may be necessary to use a separate capacitor in the position of 402 to temporarily store the charge at high speed until the integrator can absorb it in due time, but the value of such a capacitor becomes relatively non-critical compared to the value of the integration capacitor incorporated into the operational amplifier based integrator.

The utility of a signal cancellation means 405 is described in U.S. Pat. No. 4,879,461 [5], as well as in U.S. Pat. No. 5,730,165. The disclosure of U.S. Pat. No. 4,879,461 is herein incorporated by reference. The purpose of signal cancellation is to reduce the voltage (i.e. charge) build-up on the charge integrator 402 concurrently with the generation of each burst (positive going transition of the drive channel), so as to permit a higher coupling between the driven electrodes and the receiving sense electrodes. Charge cancellation permits measurement of the amount of coupling with greater linearity, because linearity is dependent on the ability of the coupled charge from the driven electrode E to the sense electrode R to be sunk into a ‘virtual ground’ node over the course of a burst. If the voltage on the charge integrator 402 were allowed to rise appreciably during the course of a burst, the voltage would rise in inverse exponential fashion. This exponential component has a deleterious effect on linearity and hence on available dynamic range.

FIGS. 6A and 6B show only one example of circuitry which may be used in embodiments of the invention. Any other known circuitry used in active electrode capacitance measurement circuitry could equally be used, for example circuitry such as described in U.S. Pat. No. 5,648,642 [6]. In principle the sense circuitry associated with the sense channel S could be something as simple as a current meter configured to measure the root mean square (RMS) current (e.g. a voltmeter configured to measure an RMS voltage drop across a resistance) of the signal coupled to the sense electrode S from the driven electrode D.

To summarise the operation of the circuitry shown in FIGS. 6A and 6B, when activated, the current drive channel D (which will be one of D1, D2, D3 or D4 depending on position in the measurement sequence/acquisition cycle) applies a time-varying drive signal to the associated drive electrode E (which will be one of E1, E2, E3 or E4). The drive channel D may comprise a simple CMOS logic gate powered from a conventionally regulated supply and controlled by the sensor controller 20 to provide a periodic plurality of voltage pulses of a selected duration (or in a simple implementation a single transition from low-to-high or high-to-low voltage, i.e. a burst of one pulse). Alternatively, the drive channel D may comprise a sinusoidal generator or generator of a cyclical voltage having another suitable waveform. A changing electric field is thus generated on the rising and falling edges of the train of voltage cycles applied to the driven electrode E. The driven electrode E and the sense electrode R are assumed to act as opposing plates of a capacitor having a capacitance C_{E}. Because the sense electrode is capacitively coupled to the driven electrode E, it receives or sinks the changing electric field generated by the driven electrode E. This results in a current flow in the sense electrode R induced by the changing voltage on the driven electrode D through capacitive differentiation of the changing electric fields. The current will flow towards (or from, depending on polarity) the sense channel S in the controller 20. As noted above, the sense channel S may comprise a charge measurement circuit configured to measure the flow of charge into/out of (depending on polarity) the sense channel caused by the currents induced in the sense electrode.

The capacitive differentiation occurs through the equation governing current flow through a capacitor, namely:

$${I}_{E} = {C}_{E} \times \frac{d V}{d t}$$

where I_{E} is the instantaneous current flowing to the sense channel S and dV/dt is the rate of change of voltage applied to the driven electrode E. The amount of charge coupled to the sense electrode R (and so into/out of the sense channel S) during an edge transition is the integral of the above equation over time, i.e.

Q_{E}=C_{E}×V.

The charge coupled on each transition, Q_{E}, is independent of the rise time of V (i.e. dV/dt) and depends only on the voltage swing at the driven electrode E (which may readily be fixed) and the magnitude of the coupling capacitance C_{E} between the driven electrode D and sense electrode E. Thus a determination of the charge coupled into/out of charge detector comprising the sense channel S in response to changes in the drive signal applied to the driven electrode E is a measure of the coupling capacitance C_{E} between the driven electrode E and the sense electrode R.

The capacitance of a conventional parallel plate capacitor is almost independent of the electrical properties of the region outside of the space between the plates (at least for plates that are large in extent compared to their separation). However, for a capacitor comprising neighbouring electrodes in a plane (i.e. a capacitor comprising a one of the drive electrodes E1, E2, E3, E4 and the sense electrode R of the sensor 12 shown in FIG. 2) this is not the case. This is because at least some of the electric fields connecting between the drive electrode E and the sense electrode R “spill” out from the substrate. This means the capacitive coupling (i.e. the magnitude of C_{E}) between respective ones of the drive electrodes E1, E2, E3, E4 and the sense electrode R is to some extent sensitive to the electrical properties of the region in the vicinity of the electrodes into which the “spilled” electric field extends.

In the absence of any adjacent objects, the magnitude of the respective values of capacitance C_{E} between the different drive electrodes and the sense electrode is determined primarily by the geometry of the electrodes, and the thickness and dielectric constant of the sensor substrate and overlying cover panel. However, if an object, such as a pointing finger, is present in the region into which the electric field spills outside of the substrate, the electric field in this region may be modified by the electrical properties of the object. This causes the capacitive coupling between the respective drive electrodes and the sense electrode to change, and thus the measured charge coupled from each of the driven electrodes into/out of the charge detector comprising the sense channel changes. Furthermore the magnitude of the change will depend on the change in the capacitances between the respective ones of the drive electrodes and the sense electrode caused by the pointing object, which will be different for each drive electrode depending on the position of the pointing object.

For example, if a user places a finger in the region of space occupied by some of the spilled electric fields between a driven electrode E and the sense electrode R, the capacitive coupling of charge between the electrodes will be reduced because the user will have a substantial capacitance to ground (or other nearby structures whose path will complete to the ground reference potential of the circuitry controlling the sense element). This reduced coupling occurs because the spilled electric field which is normally coupled between the drive electrode E and sense electrode R is in part diverted away from the sense electrode to earth. This is because the pointing object adjacent the sensor acts to shunt electric fields away from the direct coupling between the electrodes.

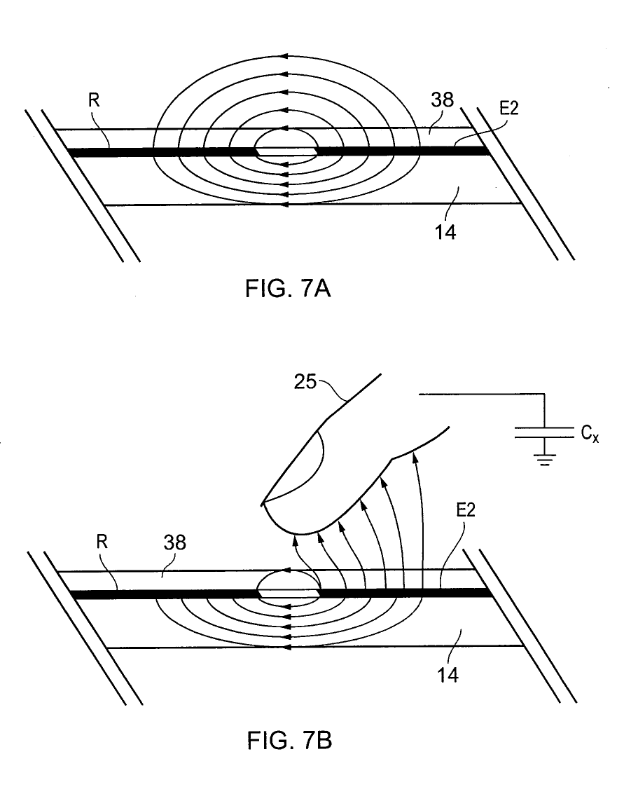

FIGS. 7A and 7B schematically show section views of a small region of the sensor 12 shown in FIG. 2 in which the electric field lines connecting between a driven one of the drive electrodes (here drive electrode E2) and the sense electrode R are schematically shown. Thus in FIGS. 7A and 7B a section of the substrate 14 is shown with neighbouring portions of drive electrode E2 and sense elements R.

FIG. 7A schematically shows the electric fields when the drive electrode E2 is being driven and there is no object adjacent the sensor 12. FIG. 7B shows the electric fields when there is an object adjacent the sensor (i.e. a user's finger 25 having a capacitance Cₓ to ground). When there is no object adjacent the sensor (FIG. 7A), all of the electric field lines shown connect between the drive electrode E2 and the sense electrode R. However, when the user's finger 25 is adjacent the sensor 12, some of the electric field lines that pass outside of the substrate 14 are coupled to ground through the finger 25. Thus fewer field lines connect between the drive electrode E2 and the sense electrode R and the capacitive coupling between them is accordingly reduced.

Thus by monitoring the amount of charge coupled between respective ones of the drive electrodes and the sense electrode, changes in the amount of charge coupled between them can be identified and used to determine if an object is adjacent the sensor (i.e. whether the electrical properties of the region into which the spilled electric fields extend have changed), and if so, where the object is located based on the relative extent to which it effects the different drive channels/drive electrodes.

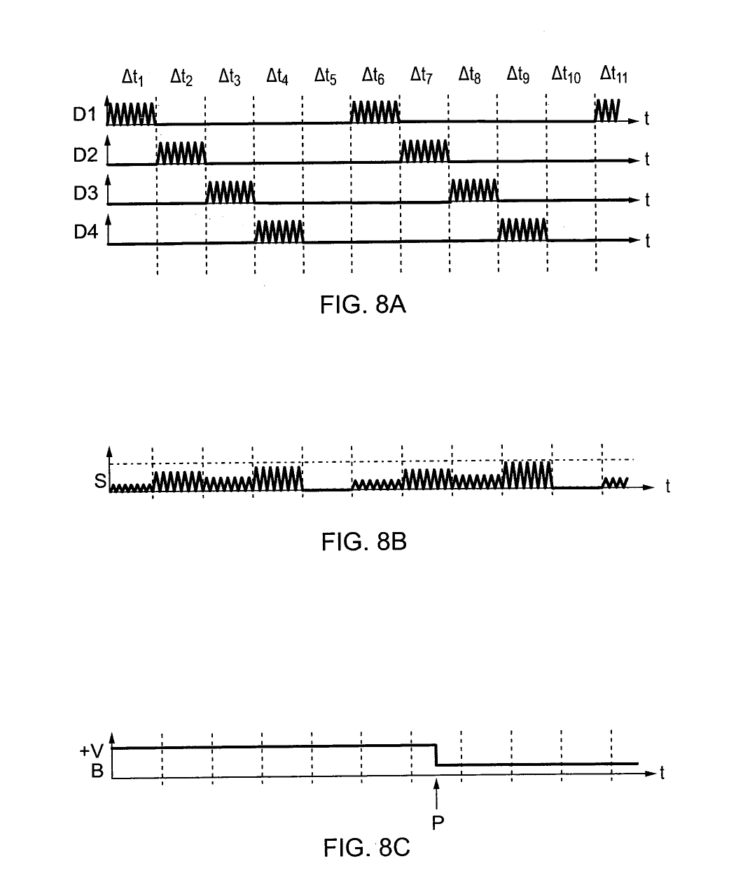

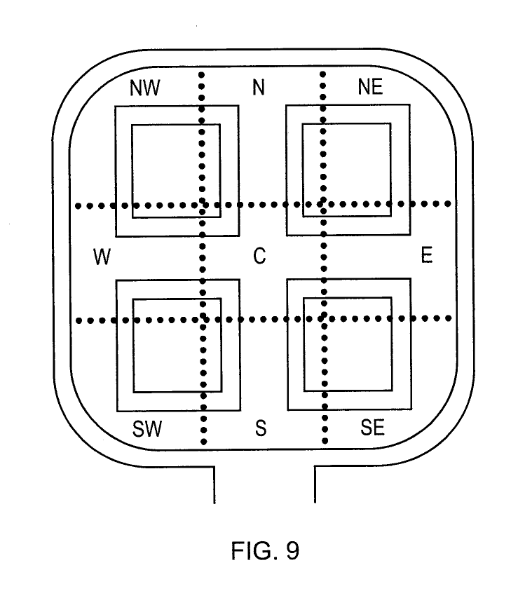

FIG. 8A schematically shows a sequence of drive signals supplied by drive channels D1, D2, D3, D4 to the respective drive electrodes E1, E2, E3, E4 of the sensor shown in FIG. 2 during a measurement acquisition cycle. FIG. 8B schematically shows the magnitude of a component of the respective drive signals shown in FIG. 8A which is coupled to the sense electrode of the sensor shown in FIG. 2 during a measurement acquisition cycle. FIG. 8C schematically shows the magnitude of an input voltage to a mechanical switch sense channel of the sensor shown in FIG. 2 during a measurement acquisition cycle;

The sequences shown in FIGS. 8A, 8B and 8C are divided into a series of time bins of duration Δt. Each measurement acquisition cycle (i.e. a period in which a position estimate and the state of the mechanical switch is determined) comprises five time bins. Thus referring to FIG. 8A, a first measurement acquisition is made during time bins Δt₁, Δt₂, Δt₃, Δt₄, and Δt₅. In time bin Δt₁ drive channel D1 is activated and a drive signal is applied to drive electrode E1. In time bin Δt₂ drive channel D2 is activated and a drive signal is applied to drive electrode E2. In time bin Δt₃ drive channel D3 is activated and a drive signal is applied to drive electrode E3. In time bin Δt₄ drive channel D4 is activated and a drive signal is applied to drive electrode E4. In time bin Δt₅ none of the drive channels are activated. A subsequent measurement acquisition is made during time bins Δt₆, Δt₇, Δt₈, Δt₉, and Δt₁₀. During this (and further) subsequent measurement acquisition cycles, the sequence of drive signals from time bins Δt₁, Δt₂, Δt₃, Δt₄, and Δt₅ is repeated. Referring to FIG. 8B, a dot-dashed line indicates the level of signal coupled from the respective ones of the drive electrodes to the sense electrode when there is no object adjacent the sensor. This lever is determined according to the mutual capacitance between respective ones of the drive electrodes and the sense electrodes. It is assumed to be the same for each drive electrode because of the high degree of geometric symmetry.

FIGS. 8A, 8B and 8C will now be described by way of an example in which a user has positioned the centroid of his finger over the point identified by reference symbol T in FIG. 2 at some point prior to time bin Δt₁, and maintains his finger “hovering” over this position until a point at time P about midway through time bin Δt₆, at time P the user pushes down on the sensor surface. It will be appreciated that the dimensions of a typical user's finger will be such that the finger tip has a characteristic width of around 15 mm or so over the sensor with a centroid of the finger tip being nearer to the sensor surface than other parts of the finger tip. Thus although a single point T is marked in FIG. 2 corresponding to the centroid of the user's finger tip, there will in general be at least some level of capacitive coupling between the finger tip and the different drive electrodes because of the finger tip's relative extent compared to the characteristic size of the sensitive area of the sensor (i.e. here around 16 mm)

In time bin Δt₁, a relatively small signal is seen at the sense channel S as shown in FIG. 8B. This is because the capacitive coupling between the drive electrode E1 being driven in this time bin, and the sense electrode R is strongly disturbed by the presence of the finger because of its proximity. Thus the coupling is more like that shown in FIG. 7B than FIG. 7A.

In time bin Δt₂, on the other hand, a stronger signal is seen at the sense channel S. This is because the capacitive coupling between drive electrode E2 and the sense electrode R is not so strongly disturbed by the presence of the finger. This is because the parts of the finger tip which overlay the region between the drive electrode E2 and the sense electrode R are on average further from the electrodes than in the case for the parts of the finger tip that overlay the region between the drive electrode E1 and the sense electrode R (because of the rounded end to the finger tip). Furthermore, some of the region between the drive electrode E2 and the sense electrode R may not be overlaid by the finger at all. E.g. for the characteristic size of sensor shown in FIG. 2, the gap region on the right hand side of drive electrode E2 is around 1 cm from the centroid of the user's finger tip, but a user's finger tip will typically have a radius less than this. This means the coupling in this region will be more like that shown in FIG. 7A than FIG. 7B (i.e. strong coupling of drive signal), and the coupling in the regions of the gap between the drive electrode E2 and the sense electrode R which are overlaid by the finger will be somewhere between that shown in FIG. 7A and that shown in FIG. 7B.

In time bin Δt₃, a signal which is stronger than that seen in time bin Δt₁, but weaker than that seen in time bin Δt₂ is observed. This is because the capacitive coupling between the drive electrode E3 and the sense electrode adjacent R is disturbed by the presence of the finger more than for drive electrode E2 but less than for drive electrode E1. This is again due to differences in relative proximity and degree of overlap between the finger and the gap regions between the respective drive electrodes and the sense electrode.

In time bin Δt₄, the signal seen at the sense channel is stronger than in any other time bins. This is because the capacitive coupling between drive electrode E4 and the sense electrode R is least disturbed by the presence of the finger because this drive electrode is farthest from the centroid of the user's finger.

Thus at the end of time bin Δt₄, the degree of drive signal coupling between the respective drive electrodes and the sense electrode has been observed. Whereas with no object present adjacent the sensor these couplings are the same magnitude for each drive electrode (i.e. at the level of the dot-dashed line in FIG. 8B), the levels are different when the finger is present. Here it will be assumed that the signal strengths are S^{E1}, S^{E2}, S^{E3} and S^{E4} respectively for drive electrodes E1, E2, E3 ad E4.

In time bin Δt₄, the signal seen at the sense channel is zero. This is because none of the drive electrodes are being driven. The duration of time bin Δt₄ may thus be used to calculate a position estimate from the coupling signals S^{E1}, S^{E2}, S^{E3} and S^{E4} seen during the preceding four time bins. In this example the mechanical switch sense channel is also configured to sample the voltage applied to it to determine the status of the mechanical switch during time bin Δt₄. This determination is in effect an instantaneous determination (i.e. a straightforward voltage measurement) and is assumed to occur at the beginning of time bin Δt₄.

The processing unit of the sensor controller 20 in this example determines a position estimate from the measured coupling signals S^{E1}, S^{E2}, S^{E3} and S^{E4} as follows. (It is noted here for ease of explanation that the amplitudes of the signals seen in FIG. 8B are taken as being indicative of the degree of capacitive coupling between the drive electrodes and the sense electrodes. As noted above in relation to FIGS. 6A and 6B, in practice the measured output from the sense channels in this example sensor will be an estimate of the integrated charge transferred during a burst of drive signals (e.g. during a time bin), or the number of drive signals needed to raise a transferred amount of charge to a threshold level. However, this is not significant since both of these depend directly on signal amplitude.)

Before a position is determined, a determination is made to decide if any of the measured coupling signals are significantly different from the quiescent coupling signal value S^{Q} (i.e. the signals seen for each drive electrode when no object is present and schematically indicated by the dot-dashed line in FIG. 8B) that an object is deemed to be adjacent the sensor. If, for example, the measured coupling signals S^{E1}, S^{E2}, S^{E3} and S^{E4} are identical to S^{Q}, or only different from S^{Q} by an amount less than a threshold, it is determined that no object is adjacent the sensor and so a null output should be provided. However, if at least one (or an average) measured signal coupling differs from the quiescent coupling signal value S^{Q} by more than a predetermined threshold amount, the processing unit in the controller 20 determines that an object is adjacent the sensor and proceeds to calculate a position.

Positions are determined along the X and Y directions separately from one another and in a ratiometric manner.

Thus position along X is may be determined from the formula:

X=(S^{E1}+S^{E3})/(S^{E1}+S^{E2}+S^{E3}+S^{E4}) (1)

While position along Y is may be determined from the formula:

Y=(S^{E1}+S^{E2})/(S^{E1}+S^{E2}+S^{E3}+S^{E4}) (2).

Positions along X and Y may similarly be determined based on the following formulae (these will yield results which are one minus the results of the corresponding equations 1 or 2):

X=(S^{E2}+S^{E4})/(S^{E1}+S^{E2}+S^{E3}+S^{E4}) (3)

and

Y=(S^{E3}+S^{E4})/(S^{E1}+S^{E2}+S^{E3}+S^{E4}) (4).

In general, the processing unit of the controller 20 will be configured to transform the estimated X and Y positions into a digitised dimensionless normalised number, e.g. from −64 to +63 (7 bits of resolution), according to which a position of (X, Y)=(0, 0) corresponds with an estimated position for a touch/adjacent object at the centre of the sensor sensitive area, while a position of (X, Y)=(−64, −64) corresponds with an estimated position at a lowermost and leftmost corner of the sensitive area of the sensor (for the orientation shown in FIG. 2), and so on.

Although the above equations are cast in terms of the absolute signal values S^{E1}, S^{E2}, S^{E3} and S^{E4}, this is for simplicity and ease of explanation. Other equations could equally be used which are cast in terms of other parameters. For example, the magnitude of the change in the signals from their quiescent values may be used, e.g. ΔS^{E1}=S^{Q}−S^{E1}, ΔS^{E2}=S^{Q}−S^{E2}, etc. (assuming here the same quiescent value S^{Q} for each drive electrode). In this case the corresponding equations would be:

X=(ΔS^{E1}+ΔS^{E3})/(ΔS^{E1}+ΔS^{E2}+ΔS^{E3}+ΔS^{E4}) (5)

Y=(ΔS^{E1}+ΔS^{E2})/(ΔS^{E1}+ΔS^{E2}+ΔS^{E3}+ΔS^{E4}) (6)

X=(ΔS^{E2}+ΔS^{E4})/(ΔS^{E1}+ΔS^{E2}+ΔS^{E3}+ΔS^{E4}) (7)

Y=(ΔS^{E3}+ΔS^{E4})/(ΔS^{E1}+ΔS^{E2}+ΔS^{E3}+ΔS^{E4}) (8)

In principle the above equations will yield position estimates ranging from 0 to 1. For example, referring to Equation 7, a value of X=0 indicates the capacitive couplings from drive electrodes E2 and E4 (which are the electrodes in the right hand column) to the sense electrode are unaffected by the presence of an object (i.e. ΔS^{E2} and ΔS^{E4} are zero). If ΔS^{E1} and ΔS^{E3} are also zero, no object is present. If ΔS^{E1} and ΔS^{E3} are not zero (or at least satisfy a predetermined detection threshold), an object is present, and will be deemed to be at the far left of the sensitive area (since it does not effect the right-hand electrodes). A value of X=1 on the other hand indicates the capacitive couplings from drive electrodes E1 and E3 (which are the electrodes in the left hand column) to the sense electrode are unaffected by the presence of an object (i.e. ΔS^{E1} and ΔS^{E3} are zero). If ΔS^{E2} and ΔS^{E4} are also zero, no object is deemed present. If ΔS^{E2} and ΔS^{E4} are not zero (or at least satisfy a predetermined detection threshold), an object is present, and will be deemed to be at the far right of the sensitive area.

In practice it is unlikely that the extreme values of 0 and 1 will arise because the scale of the sensor is such that an object anywhere adjacent the sensor will affect the signals associated with all drive electrodes to at least some degree. Empirical data may be used to provide a suitable transform function from values provided by the equations such as those above to positions. For example, it may be empirically found for a given sensor design that the value of X determined according to Equation 7 varies linearly with actual position of a pointing object/finger from 0.2 to 0.8 across the full extent of the sensor's sensitive area. Thus for seven bit digitisation, an output corresponding to (((X−0.2)/0.6*128)−64) might be used to provide a linear increase from −64 to +63 for values of X from 0.2 to 0.8.

Similar principles apply to position estimates in the Y direction.

Thus at the end of each measurement acquisition cycle, the controller 20 has determined a position estimate X, Y for the centroid of an object adjacent the sensor (assuming an object is deemed adjacent the sensor) and also has determined the status O of the mechanical switch 16 during that measurement acquisition cycle. This may then be output for a main controller of a device in which the sensor is incorporated to receive and act accordingly depending on how the device controller has been programmed to respond to determined user input (touch position and mechanical switch activation). The process may then be repeated for the next measurement acquisition cycle. This may follow immediately from the preceding measurement acquisition cycle (as in the present case) or there may be a delay. For example, if is determined that no object is present adjacent the sensor, a relatively long delay may be instigated to reduce power consumption.

Thus in the example described above, the output from the controller 20 at the end of the first measurement acquisition during time bins Δt₁, Δt₂, Δt₃, Δt₄, and Δt₅ might be such as to indicate (X, Y, O)=(−40, +10, 0). I.e. X position is 40 positional resolution units to left of centre and 10 positional resolution units above centre, and the status of the mechanical switch status O is 0 (switch open).

However, the output from the controller 20 at the end of the measurement acquisition during time bins Δt₆, Δt₇, Δt₈, Δt₉, and Δt₁₀ might be such as to indicate (X, Y, O)=(−40, +10, 1). I.e. X, Y position unchanged, but the mechanical switch status O changed to 1 (switch closed). The change in mechanical switch status is determined by the controller 20 from the drop in voltage seen at the mechanical switch sense channel B when it is sampled at the beginning of time bin Δt₁₀. The voltage seen here is lower than when the mechanical switch sense channel B was sampled during the previous measurement acquisition cycle at the beginning of time bin Δt₅ because of the switch closure at time P.

It is noted that in general the status of the mechanical switch could be sensed in parallel with the position estimate measurement acquisition i.e. at any time during the first four time bins of each measurement acquisition. In some examples a single one of the input/output (I/O) pins of a microcontroller providing the functionality of the controller 20 may be used as a drive signal output for one of the drive electrodes and also as an input for the mechanical switch sense channel B. For example, the “shared” I/O pin may be configured as an output pin for supplying a drive signal to one of the drive electrodes in the corresponding time bin for that drive electrode, and be re-configured as an input pin for the mechanical switch sense channel B receiving the input from the circuitry 18 associated with the mechanical switch during the time bin in which the status of the mechanical switch is to be determined. This has the advantage of reducing the number of I/O pins required. One consequence of this however is that position estimates cannot be made when the mechanical switch is activated (because the drive signal supplied via the shared I/O pin is sunk to ground (via ρ2) through the mechanical switch.

A device controller of a device in which the sensor is incorporated may be configured to respond to user inputs as determined by the sensor in any manner as desired by the designer of the interface system of the device. An advantage of the sensor is that it provides a simple Cartesian position estimate that may be processed and acted upon in any desired manner. E.g. the Cartesian position estimate may be converted into a polar coordinate to provide a scroll-wheel like functionality if that is what is desired by the interface designer. This makes the sensor very flexile and readily integrated into a wide range of user interfaces for different products to be operated in different ways. Any device specific modes of operation (e.g. rotary scrolling, absolute or relative position indications) can be provided for in post processing of the “raw” X and Y co-ordinates. Furthermore, the status O of the mechanical switch may be combined with X, Y position information to provide for a number of “virtual” mechanical switches/buttons.

For example, FIG. 9 schematically shows a line drawing of a portion of the sensor 12 shown in FIG. 2 which broadly corresponds to the sensitive area of the sensor. The sensitive area is shown as being notionally divided by dotted line into 9 sectors labelled NW, N, NE, W, C, E, SW, S and SE. A device controller receiving the output signals (X, Y, O) may be configured so that when the mechanical switch is open, the X, Y positional information is processed as a conventional analogue two-dimensional position input in any desired manner (e.g. as an absolute position input device or a motion-sensitive input device). However, when the mechanical switch is activated (closed), the device controller receiving the output signals (X, Y, O) may then be configured to determine from the X, Y positional information which of the notional nine sectors shown in FIG. 9 includes the position of the touch at the time the mechanical switch is closed, and to treat this as a user selecting one of nine notional mechanical switches corresponding to the different sectors. Thus, for example, activation of the mechanical switch 16 by a finger pressing at a position deemed to be within the sector labelled N in FIG. 9 may be taken as an input command to move up one place in a menu list associated with the operation of the device being controlled. On the other hand, activation of the mechanical switch 16 by a finger pressing at a position deemed to be within the sector labelled E in FIG. 9 may be taken as an input command to move to the right one place in a menu list associated with the operation of the device being controlled. Activation of the mechanical switch by a finger within the sector labelled C in FIG. 9 may be taken as a “select/OK” command, and so on. Thus the sensor in effect provides a plurality of virtual mechanical switches while requiring only a single physical mechanical switch.

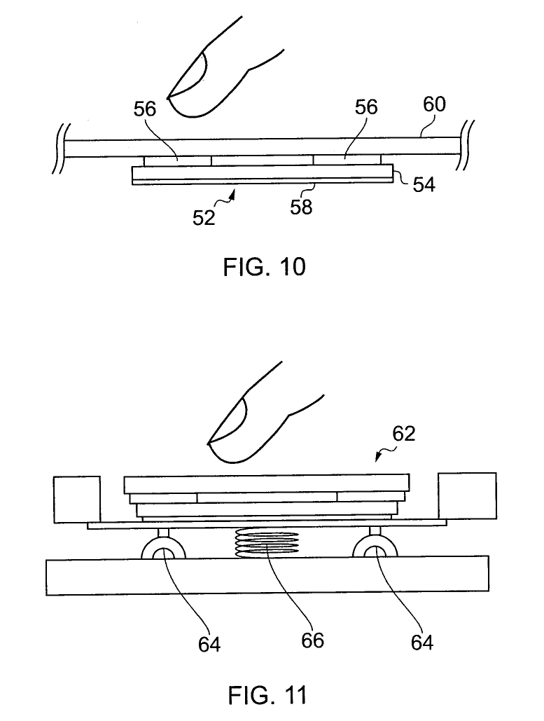

FIG. 10 schematically shows in vertical section view a sensor 52 for determining the position of an object in two-dimensions according to another embodiment of the invention. The sensor 52 shown in FIG. 10 differs from the sensor 12 shown in FIG. 2 in that it does not include a mechanical switch. Thus the substrate of the sensor is not mounted on a floating platform. The sensor 52 is instead directly adhered to the underside of an extended cover panel 60 provided by a housing of a device in which the sensor 52 is incorporated. The sensor is otherwise similar to that shown in FIG. 2. Thus the sensor comprises a substrate 54, an electrode pattern 56, a ground plane 58 and a controller (not shown) which are similar to (save for the absence of features relating to the mechanical switch) and will be understood from the corresponding elements of the sensor shown in FIG. 2. This sensor may thus be used where there is no desire to provide any mechanical switch functionality.

FIG. 11 schematically shows in vertical section view another sensor 62 for determining the position of an object in two-dimensions according to another embodiment of the invention. The sensor 62 shown in FIG. 11 differs from the sensor 12 shown in FIG. 2 in that it includes more mechanical switches. Two mechanical switches 64 are shown in FIG. 11. As a result a different resilient mounting configuration is employed in this example (schematically shown as a single centrally placed helical spring 66). This type of sensor structure may be preferred if it desired to provide a plurality of “real”, as opposed to “virtual”, mechanical switched. E.g. to reduce the amount of movement required to activate the switches, or to provide for some redundancy.

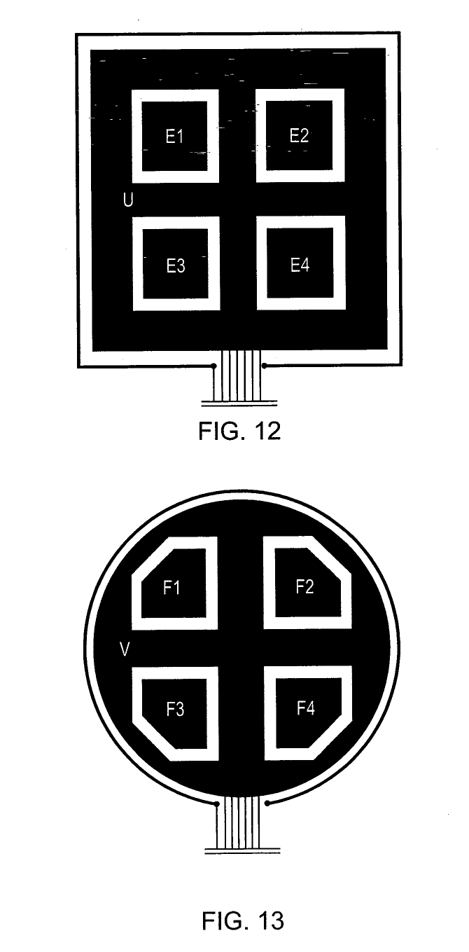

It will be appreciated that the specific electrode pattern shown in FIG. 2 is only one example and other broadly similar designs may be employed. For example, FIGS. 12, 13 and 14 schematically show electrode patterns for use in sensors according to other embodiments of the inventions.

For the sensor shown in FIG. 12, the electrode pattern defining the sensitive area of the sensor consists of four drive electrodes E1, E2, E3, E4 arranged in a two-by-two array and a single electrically continuous sense electrode U arranged to extend around the four drive electrodes. Apart from differences in the specific electrode pattern, the sensor shown in FIG. 12 is otherwise similar to and will be understood from the sensor shown in FIG. 2 and discussed above both in terms of structure and operation. The drive electrodes E1, E2, E3, E4 of the sensor shown in FIG. 12 have the same layout and relative dimensions and separations as the correspondingly labelled drive electrodes of the sensor shown in FIG. 2. However, the sense electrode U of the sensor shown in FIG. 12 is a different shape to the sense electrode R of the sensor shown in FIG. 2. In particular, the sense electrode R of the sensor shown in FIG. 2 is in the form of a square with rounded corners, whereas the sense electrode U of the sensor shown in FIG. 12 is in the form of a square without rounded corners. The sense electrodes are otherwise similar, e.g. they may have the same characteristic overall width, and the relative dimensions of the inner parts of the sense electrodes (i.e. the portions running between the drive electrodes) may be the same. This difference in shape for the sense electrodes does not significantly affect the operation of the sensor, but may be preferred in some implementations, e.g. for aesthetic reasons.

For the sensor shown in FIG. 13, the electrode pattern defining the sensitive area of the sensor consists of four drive electrodes F1, F2, F3, F4 arranged in a two-by-two array and a single electrically continuous sense electrode V arranged to extend around the four drive electrodes. Apart from differences in the specific electrode pattern, the sensor shown in FIG. 13 is again otherwise similar to and will be understood from the sensor shown in FIG. 2. The sense electrode V of the sensor shown in FIG. 13 is a different shape to the sense electrode R of the sensor shown in FIG. 2. In particular, the sense electrode V of the sensor shown in FIG. 13 is in the form of a circle. However, the sense electrode V may have the same overall characteristic width as the sense electrode R of the sensor shown in FIG. 2 (i.e. the diameter of the sense electrode shown in FIG. 12 may broadly correspond with the linear extent of the sense electrode shown in FIG. 2). The drive electrodes F1, F2, F3, F4 of the sensor shown in FIG. 12 correspond closely with the drive electrodes E1, E2, E3, E4 of the sensor shown in FIG. 2 in terms of their overall layout and relative dimensions and separations, save for the outermost corners of the drive electrodes being cut away to accommodate the circular shaped sense electrode V. Again the differences in shapes for the electrodes does not significantly affect the principles underlying the operation of the sensor, but may be preferred in some implementation for aesthetic reasons.

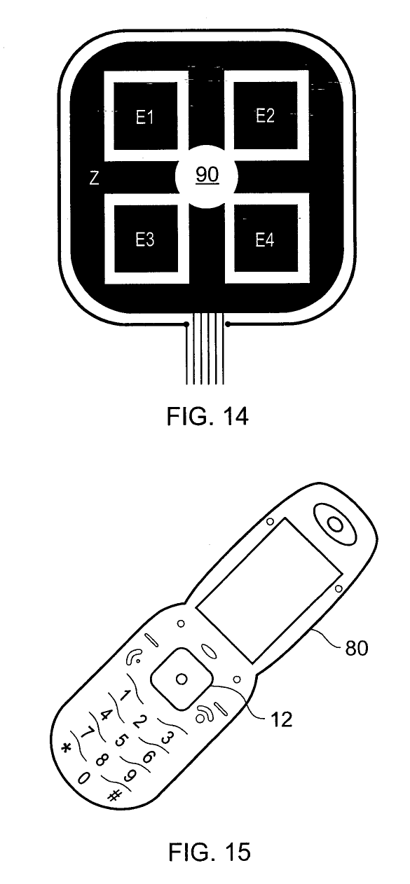

For the sensor shown in FIG. 14, the electrode pattern defining the sensitive area of the sensor comprises four drive electrodes E1, E2, E3, E4 arranged in a two-by-two array and a single electrically continuous sense electrode Z arranged to extend around the four drive electrodes. Apart from differences in the electrode pattern, the sensor shown in FIG. 14 is otherwise similar to and will be understood from the sensor shown in FIG. 2 and discussed above. The drive electrodes E1, E2, E3, E4 of the sensor shown in FIG. 14 have the same layout and relative dimensions and separations as the correspondingly labelled drive electrodes of the sensor shown in FIG. 2. However, the sense electrode Z of the sensor shown in FIG. 14 is a different shape to the sense electrode R of the sensor shown in FIG. 2. In particular, while the sense electrode Z of the sensor shown in FIG. 14 has the same overall shape as the sense electrode R shown in FIG. 2, it includes an open region 90 towards its centre. The open region 90 is a region where a part of the sense electrode is missing compared to the sense electrode R of the sensor shown in FIG. 2. Experience has shown that an open region such as this does not have a significant impact on the sensor response, and furthermore, any small impact there is, for example in reduced linearity of response, or increased cross talk between X and Y (i.e. position estimate in one direction depending on position estimate in other direction) can readily be accounted for in post processing, either in the processing unit of the sensor's controller, or in the main device controller of a device in which the sensor is incorporated. A designer may wish to include an open region for various reasons. For example a designer may wish to provide for a region of rear illumination in an otherwise opaque electrode pattern, or to provide a raised/lowered region in the substrate to assist in guiding a user's finger within the sensitive area of the sensor (e.g. so he can feel where the centre is), or to provide a central mechanical switch button protruding above the surface of the sensor/overlaying cover panel. The substrate may include a hole in the area underlying the open region 90. In other examples, an open region may be provided in other non-central parts of the sensor. Furthermore, the drive electrodes may also include open regions, e.g. for rear illumination or tactile button inclusion in these areas.

Sensors according to embodiments of the invention may be incorporated into many different kinds of device/apparatus/equipment, e.g. a personal data assistant (PDA), a portable media (e.g. MP3 or video) player, a camera etc. For example, FIG. 15 schematically shows a mobile (cellular) telephone 80 incorporating a sensor 12 such as shown in FIG. 2. The sensor in is provided in addition to a conventional telephone keypad (which may be based on mechanical or touch sensitive technology) and may be used, for example, for menu navigation and short cut feature selection.

Thus according to an embodiment of the invention, a sensor for determining a position of an object in two dimensions is provided. The sensor comprises a substrate with a sensitive area defined by a pattern of electrodes arranged thereon. The pattern of electrodes comprises four drive electrodes arranged in a two-by-two array and coupled to respective drive channels, and a sense electrode coupled to a sense channel. The sense electrode is arranged so as to extend around the four drive electrodes (i.e. to wholly or partially surround the drive electrodes, for example, so as to extend adjacent to at least three sides of the drive electrodes). The sensor may further comprise a drive unit for applying drive signals to the respective drive electrodes, and a sense unit for measuring sense signals representing a degree of coupling of the drive signals applied to the respective drive electrodes to the sense electrode. Furthermore the sensor may comprise a processing unit for processing the sense signals to determine a position of an object adjacent the sensor. The functionality of the drive channels, the sense channels, and the processing unit may be provided by a suitably programmed microcontroller.

### REFERENCES

[1] U.S. Pat. No. 7,046,230 (Apple Computer Inc.)
[2] U.S. Pat. No. 5,730,165 (Harald Philipp)
[3] U.S. Pat. No. 6,466,036 (Harald Philipp)
[4] U.S. Pat. No. 6,452,514 (Harald Philipp)
[5] U.S. Pat. No. 4,879,461 (Harald Philipp)
[6] U.S. Pat. No. 5,648,642 (Synaptics, Incorporated)

1. A sensor for determining a position of an object in two dimensions, the sensor comprising a substrate with a sensitive area defined by a pattern of electrodes arranged thereon, wherein the pattern of electrodes comprises four drive electrodes arranged in a two-by-two array and coupled to respective drive channels, and a sense electrode coupled to a sense channel, wherein the sense electrode is arranged so as to extend around the four drive electrodes.

2. A sensor according to claim 1, wherein the two-by-two array of drive electrodes is wholly surrounded by the sense electrode.

3. A sensor according to claim 1, wherein individual ones of the drive electrodes are wholly surrounded by the sense electrode.

4. A sensor according to claim 1 and further comprising a ring electrode arranged around the periphery of the sensitive area and coupled to a system ground.

5. A sensor according to claim 1, wherein the drive electrodes and the sense electrodes are arranged on a first side of the substrate and the sensor further comprises an extended ground-plane electrode arranged on a second opposing side of the substrate and coupled to a system ground.

6. A sensor according to claim 5, wherein the extended ground-plane electrode is comprises an open mesh pattern.

7. A sensor according to claim 6, wherein the open mesh pattern has a fill factor in a range of 20% to 80%.

8. A sensor according to claim 1, wherein the sensor is mounted beneath a cover panel having a thickness T, and a gap between the respective drive electrodes and the sense electrode has a-width of between one-third and two-thirds the thickness T of the cover panel.

9. A sensor according to claim 1, wherein the sensitive area has a characteristic extent W along a first direction, and the drive electrodes have widths of between W/10 and W/3 along the first direction.

10. A sensor according to claim 9, wherein the sensitive area has a characteristic extent W along a second direction, and the drive electrodes have widths of between W/10 and W/3 along the second direction.

11. A sensor according to claim 1, wherein the sensitive area has a characteristic extent W along a first direction, and portions of the sense electrode between adjacent drive electrodes have widths of between W/20 and W/5 along the first direction.

12. A sensor according to claim 11, wherein the sensitive area has a characteristic extent W along a second direction, and portions of the sense electrode between adjacent drive electrodes have widths of between W/20 and W/5 along the second direction.

13. A sensor according to claim 1 claim, wherein the sensitive area has a characteristic extent of less than a dimension of 30 mm.

14. A sensor according to claim 1, further comprising a mechanical switch, wherein the substrate of is moveably mounted with respect to the mechanical switch and arranged so that a movement of the substrate is operable to activate the mechanical switch.

15. A sensor according to claim 1, further comprising a drive unit for applying drive signals to the respective drive electrodes, and a sense unit for measuring sense signals representing a degree of coupling of the drive signals applied to the respective drive electrodes to the sense electrode.

16. A sensor according to claim 15, further comprising a processing unit for processing the sense signals to determine a position of an object adjacent the sensor.

17. A sensor according to claim 16, wherein the processing unit is operable to determine a position of an object adjacent the sensor based on a ratiometric analysis of the sense signals.

18. A sensor according to claim 17, wherein the processing unit is operable to determine the position of an object adjacent the sensor in one direction based on a ratio of a sum of the sense signals associated with an adjacent pair of drive electrodes to a sum of the sense signals associated with all of the drive electrodes.

19. A sensor according to claim 18, wherein the adjacent pair of drive electrodes comprises two drive electrodes separated along a direction normal to the direction along which the position is determined.

20. A sensor according to claim 16, wherein the drive channels, the sense channels, and the processing unit comprise a microcontroller.

21. A sensor according to claim 20, the sensor further comprising a mechanical switch, wherein the microcontroller is operable to supply a drive signal to a drive electrode through an input/output (I/O) connection at one time, and to sample the status of the mechanical switch through the same input/output (I/O) connection at a another different time.

22. (canceled)
